(19) United States
(12) Patent Application Publication
(10) Pub. No.: US 2008/0016454 A1
(43) Pub. Date: Jan. 17, 2008

(54) Data input-output device

(75) Inventor: Takuya Fukata, Osaka (JP)

Correspondence Address: Kyocera Technology Development;Intellectual Property Administration, Suite 400, 1855 Gateway Blvd., Concord, CA, 94520, US

(73) Assignee: Kyocera Mita Corporation, Osaka-shi (JP)

(21) Appl. No.: 11/823,668

(22) Filed: Jun. 28, 2007

(30) Foreign Application Priority Data
Jun. 29, 2006 (JP) JP2006-180134

(51) Int. Cl. G06F 3/048

(52) U.S. Cl. 715/764; 715/810

(57) ABSTRACT

A method for enabling an access to a remote page by simply clicking a link button without inputting page number values. A data input-output device of the present invention includes a data input unit, a display unit, and a display control unit. The display unit displays data to be selected through an input operation at the data input unit. The display control unit controls displaying the data on the display unit by page. The display unit displays up to ten items of user registration numbers and names per page. It also displays a given number of page number values of pages near a current page as page link buttons. The user selects the page link button from the data input unit. The selection leads to configuration of the page number value of the selected page link button as the new display page number value and display associated data by page.

### FIELD OF THE INVENTION

The present invention relates to a data input-output device for displaying data by page and allowing the user to select the data.

### BACKGROUND OF THE INVENTION

Japanese Patent Laid-Open 3-263217 (Patent Document 1) discloses a conventional data input-output device for displaying data by page and allowing the user to select the data. The conventional device has functions of, for instance, displaying a page in an approximate range, moving from a current page to a previous or next page, displaying a specific page by designating the page number value.

A conventional technology for displaying a search result on a search site using a web browser is to display a certain rage of pages, move forward or back a page from a current page, and so forth.

However, the conventional technology disclosed in Patent Document 1 causes inconveniences. The function for displaying pages in an approximate range makes it difficult to display a specific page. Alternatively, the function for displaying a specific page by designating the page number value is cumbersome for the user since it requires inputting the page number value. Yet alternatively, the search site using a web browser requires numerous key operations in order to display a remote page from a current page, and thus is also troublesome for the user to operate.

### SUMMARY OF THE INVENTION

An object of the present invention is to address such problems by improving accessorily to a remote page simply by clicking a link button without inputting a page number value.

A data input-output device of the present invention includes a data input unit, a display unit, and a display control unit. The display unit displays data to be selected through an input operation at the data input unit.

The display control unit displays on the screen of the display unit data to be selected from the displayed page and a given number of page number values of pages near a current page as page link buttons. Upon selection of the page link button through the input operation at the data input unit, the display control unit configures the page number value of the selected page link button as a new display page number value and controls displaying of the data by page.

Yet furthermore, the display control unit displays on the screen of the display unit a button for designating the previous or the next page from the current page. Upon selection of the button through an input operation at the data input unit, the display control unit configures a page number value of the page forwarded or moved back by one from the current page as the new display page number value and controls displaying the data by page.

Yet furthermore, the display control unit further displays on the screen of the display unit a jump button for jumping a page range which includes the page link buttons. Upon selection of the jump button through an input operation at the data input unit, the display control unit configures a page number value of the page reached by jumping the page range as the new display page number value and controls displaying the data by page.

These and other objects, features and advantages of the present invention are specifically set forth in or will become apparent from the following detailed descriptions of the invention when read in conjunction with the accompanying drawings.

### DESCRIPTION OF THE DRAWINGS

FIG. 1 is, a block diagram illustrating a configuration of an image forming device of the present invention.

FIG. 2 is a view of an operation/display panel of the image forming device when the total page number is “1.”

FIG. 3 is a view of the first page displayed on the screen of the operation/display panel of the image forming device when the total page number is “2.”

FIG. 4 is a view of the second page displayed on the screen of the operation/display panel of the image forming device when the total number of display page is “2.”

FIG. 5 is a view of the first page displayed on the screen of the operation/display panel of the image forming device when the total page number is “10.”

FIG. 6 is a view of the second page displayed on the screen of the operation/display panel of the image forming device when the total page number is “10.”

FIG. 7 is a view of the first page displayed on the screen of the operation/display panel of the image forming device when the total page number is “52.”

FIG. 8 is a view of the 11th page displayed on the screen of the operation/display panel of the image forming device when the total page number is “52.”

FIG. 9 is a view of the 12th page displayed on the screen of the operation/display panel of the image forming device when the total page number is “52.”

FIG. 10 is a flowchart illustrating a control operation of data input-output on the image forming device.

FIG. 11 is a flowchart illustrating a control operation of data input-output on the image forming device.

### DETAILED DESCRIPTION OF THE INVENTION

Exemplary embodiments of the present invention are explained below with reference to the accompanying drawings though these embodiments are not intended to limit the invention. Additionally, in some instances, well-known structures, interfaces, and processes have not been shown in detail in order not to unnecessarily obscure the present invention.

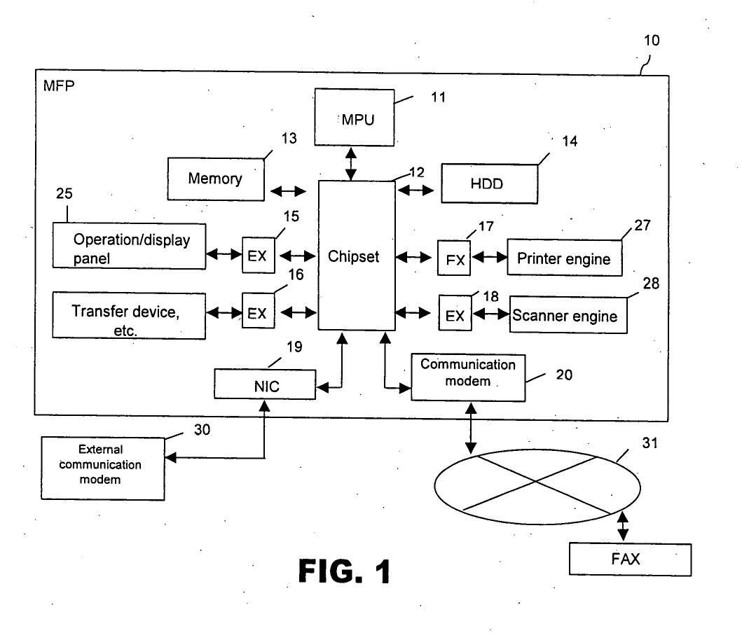

The present invention can be applied to, for instance, an image forming device 10 configured illustrated in FIG. 1.

The image forming device 10 is a MFP (Multifunction Peripheral or Multi-Functional Peripheral), which has functions of a copier, a printer, a scanner, and a facsimile. The image forming device 10 includes a MPU (Microprocessor Unit) 11, a chipset 12, a memory 13, a HDD (Hard Disk Drive) 14, EX (Extension Card)s 15 through 18, a NIC (Network Interface Card) 19, an communication modem 20, an operation/display panel 25, a paper transfer device 26, a printer engine 27, and a scanner engine 28.

The MPU 11 is connected through the chipset 12 with the memory 13, the HDD 14, the EXs 15 through 18, the NIC, the communication modem 20. The EXs 15 through 18 are connected with the operation/display panel 25, the paper transfer device 26, the printer engine 27, and the scanner engine 28, respectively.

For example, the EXs 15 through 17 are PCI (Peripheral Component Interconnect) cards, while the EX 18 is a SCSI (Small Computer Systems Interface) card for a PCI bus. Alternatively, the NIC 19 and the communication modem 20 are connected to an external communication modem 30 and a public circuit 31, respectively. The transfer device 26 includes a paper transfer device, a fuser device, and a finisher.

The HDD 14 is installed with a conventional OS (Operating System) with multiple thread functions, an integrated application which operates on the OS, and a device driver which runs under the OS.

The MPU 11 of the image forming device 10 performs a processing for an address book for searching for the user registered to the image forming device 10.

The MPU 11 also manages displaying data by page on the operation/display panel 25 for searching the user and controls receiving inputs through the panel. The operation/display panel 25 functions as a data input and a display unit so that data is input therefrom and input data is displayed thereon.

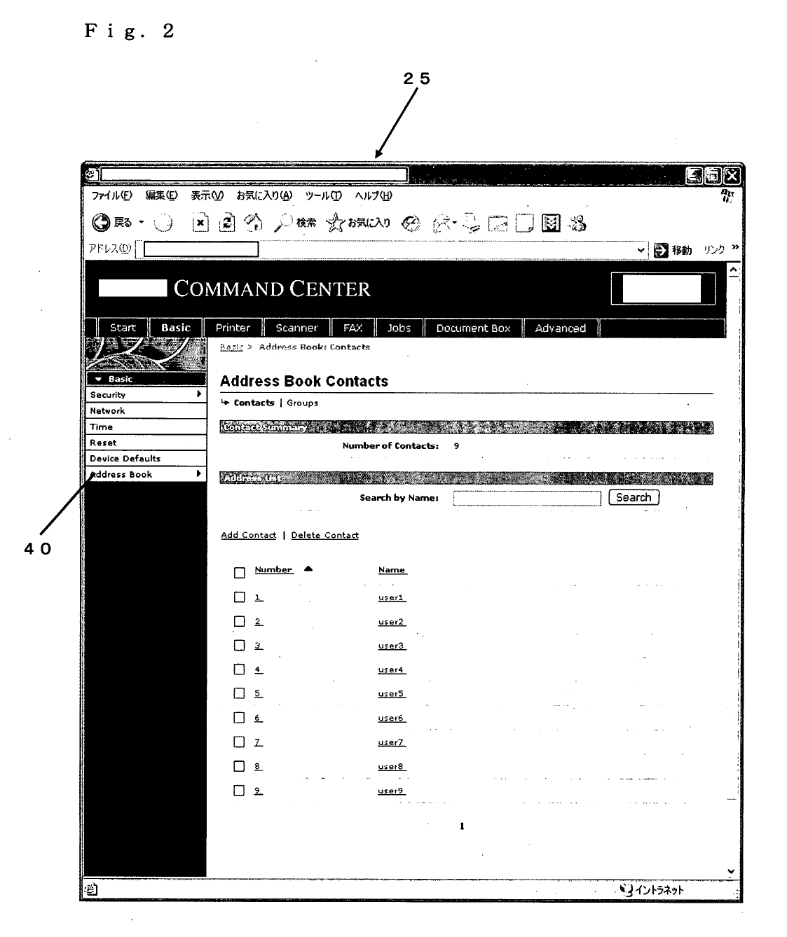

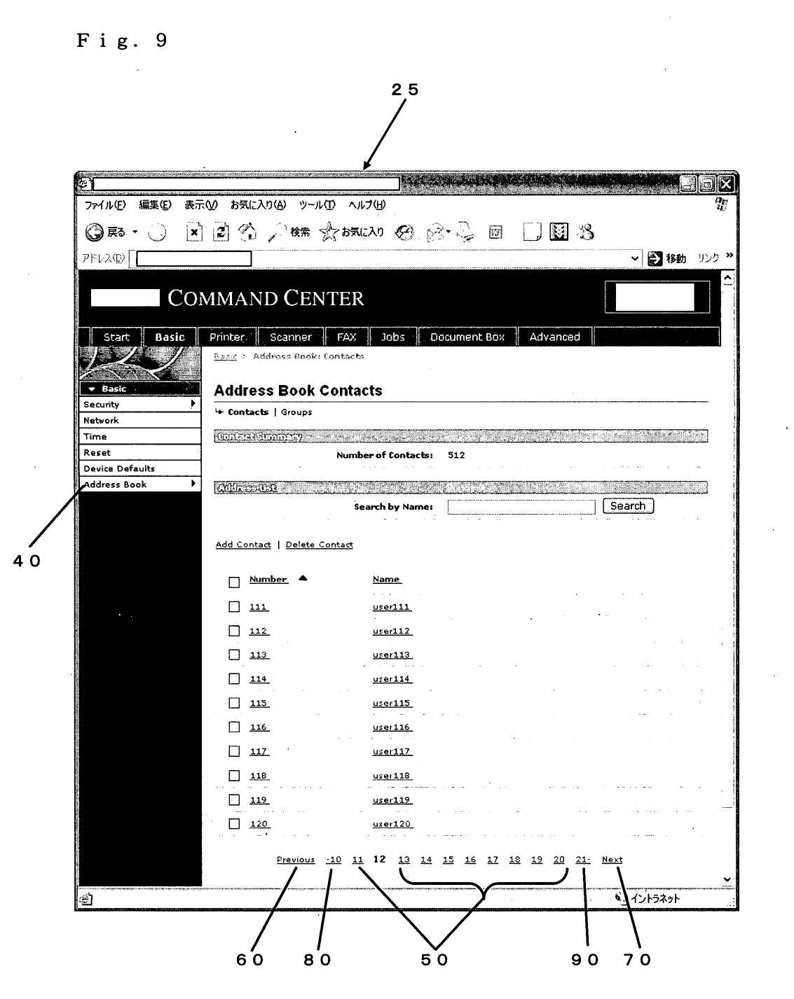

For example, as shown in FIGS. 2 and 9, clicking an address book button 40 on the screen of the operation/display panel 25 will activate a processing function of an address book for searching registered users. The activation will lead to displaying a given number of items of user registration numbers and names per page and a page link button 50 thereon. The page link button 50 indicates a given number of page number values of pages near a current page. The example displays 10 items and 10 pages.

If the page number is equal to or lower than “10,” such as registered items being “9” and the total page number being “1,” as shown in FIG. 2; 9 items of user registration numbers and names (1-10) will be displayed in the body. The page number, “1,” will be displayed at the button.

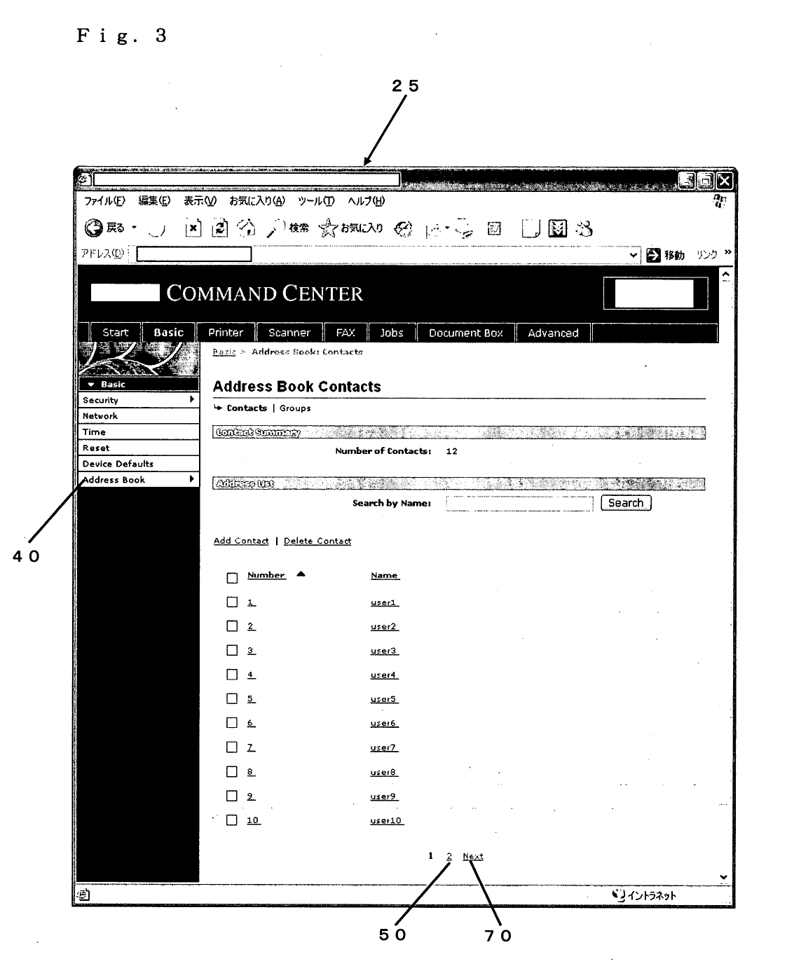

Alternatively, for instance, 12 registered items and two total page number will be displayed in a following manner. If the current display page number is “1,” ten items of user registration numbers and names (1-10) will be displayed, as shown in FIG. 3. Additionally, the current display page number, “1,” the page link button 50, “2,” and a next button 70, “Next,” will be displayed at the bottom of the page. The current display page number will not be underlined.

In FIG. 3, clicking the page number, “2,” of the page link button 50, or “Next” of the button 70 moves from the current display page, “1,” to the next page, “2.”

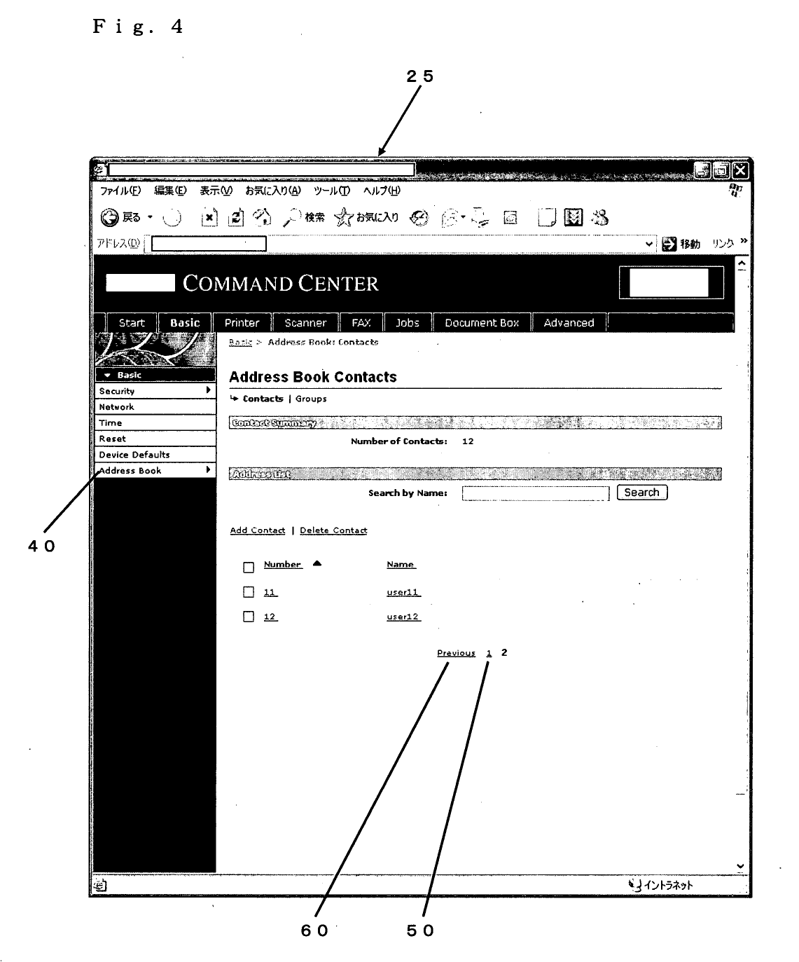

On the page, 2″ as indicated in FIG. 4, two items of user registration numbers and names (11-12) will be displayed along with a button 60, “Previous,” “2” of the current page number, and “1” of the previous page number of the page link button 50. The current page number, “2,” will be displayed without an underline.

In FIG. 4, clicking “Previous” of the button 60 or the page number, “1,” of the page link button 50 will move the display back to that of the page number, “1,” of FIG. 3.

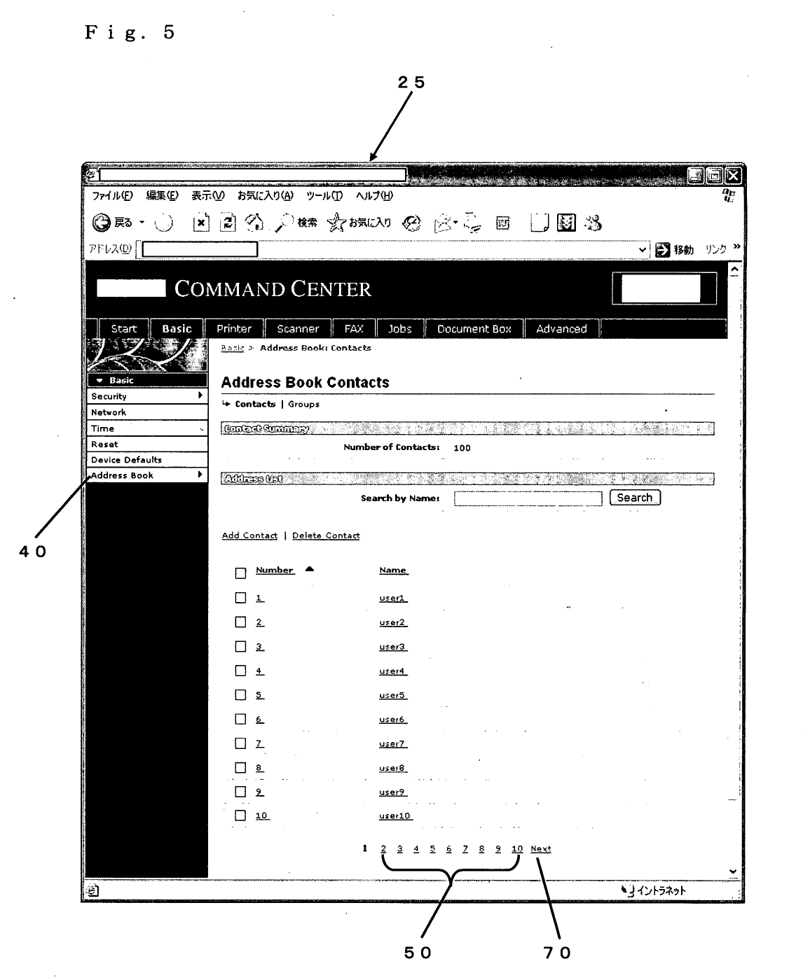

Alternatively, for instance, 100 registered items and 10 total page number will be displayed in a following manner. If the current display page number is “1,” ten items of user registration numbers and names (1-10) will be displayed, as shown in FIG. 5. Additionally, the current display page number, “1,” and the page numbers, “2,” “3,” “4,” “5,” “6,” “7,” “8,” “9,” and “10,” of the page link buttons 50, and “Next” of the button 70 will be displayed. The current display page number, “1,” will not be underlined.

On the first page in FIG. 5, the user can selectively click either one of the page numbers, “2,” “3,” “4,” “5,” “6,” “7,” “8,” “9,” and “10,” of the page link button 50 or “Next” of the button 70. By clicking it, the current display moves to the display of the selected page. For instance, clicking the page number, “2,” of the page link button 50 or “Next” of the button 70 proceeds to a display of the following page, which is the second page.

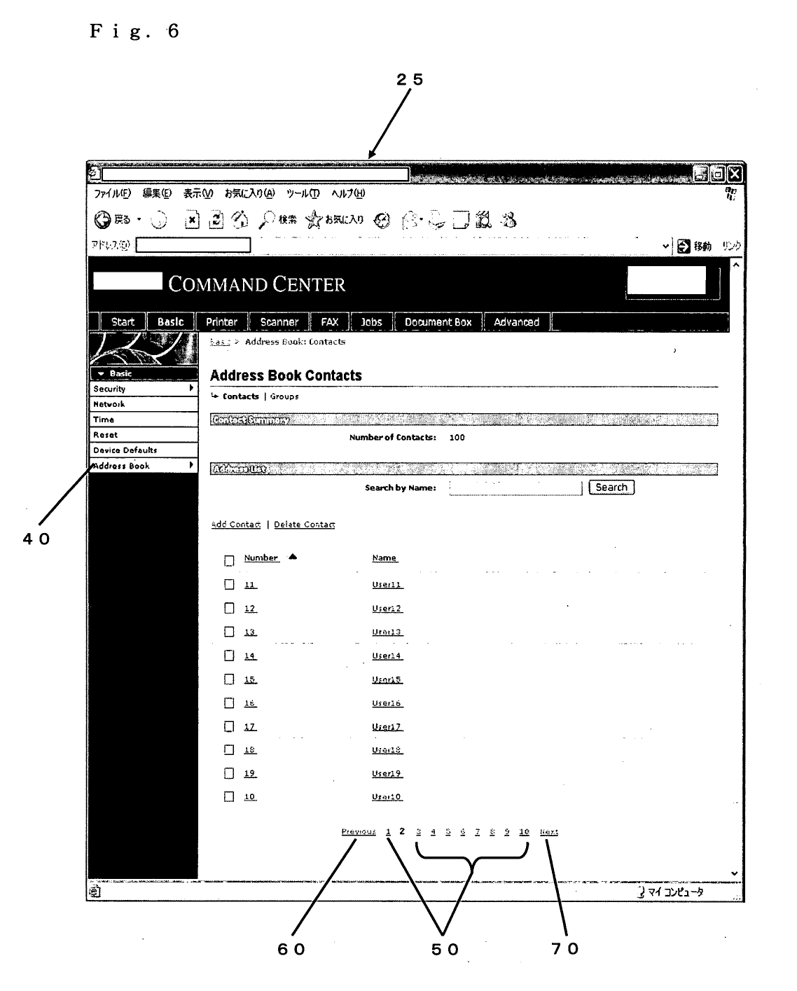

On the second page, two items of user registration numbers and names (11-12) will be displayed, as shown in FIG. 6. Additionally, “Previous” of the button 60 and the page numbers, “1,” “2,” “3,” “4,” “5,” “7,” “8,” “9,” and “10,” of the page link button 50, and “Next” of the button 70 will be displayed. The current display page number, “2,” will not be underlined.

In FIG. 6, clicking “Previous” of the button 60 or the page number, “1,” of the page link button 50 will move the display of the second page back to that of the page number, “1,” of FIG. 5.

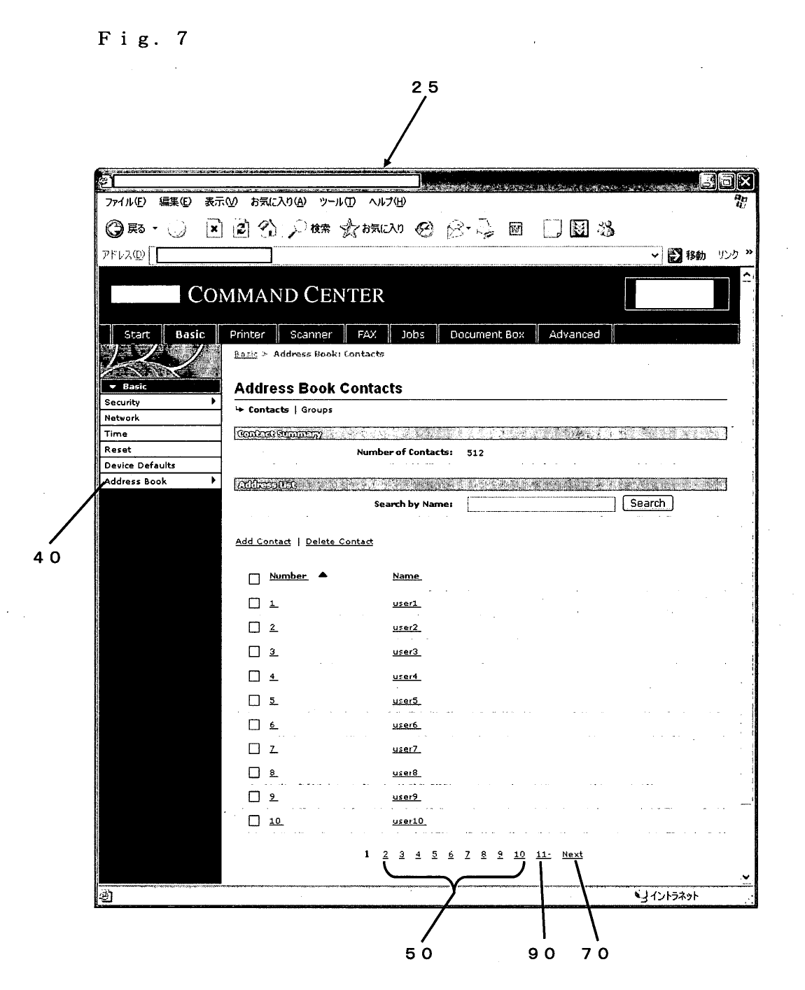

Alternatively, if the page number is equal to or above “11,” for instance, the total page number being “52” including 512 registered items, they will be displayed in a following manner. If the current display page number is “1,” ten items of user registration numbers and names (1-10) will be displayed as shown in FIG. 7. Additionally, the current display page number, “1,” the page numbers, “2,” “3,” “4,” “5,” “7,” “8,” “9,”, and “10,” of the page link buttons 50, “11-” of a jump button 90 which indicates a range of ten pages which includes according ten page link buttons 50, and “Next” of the button 70 of will be displayed. The current display page number, “1,” will not be underlined.

On the first page in FIG. 7, the user can selectively click either one of the page numbers, “2,” “3,” “4,” “5,” “6,” “7,” “8,” “9,” and “10,” of the page link button 50, “11-” of the jump button 90, or “Next” of the button 70. By clicking it, the current display moves to the display of the selected page.

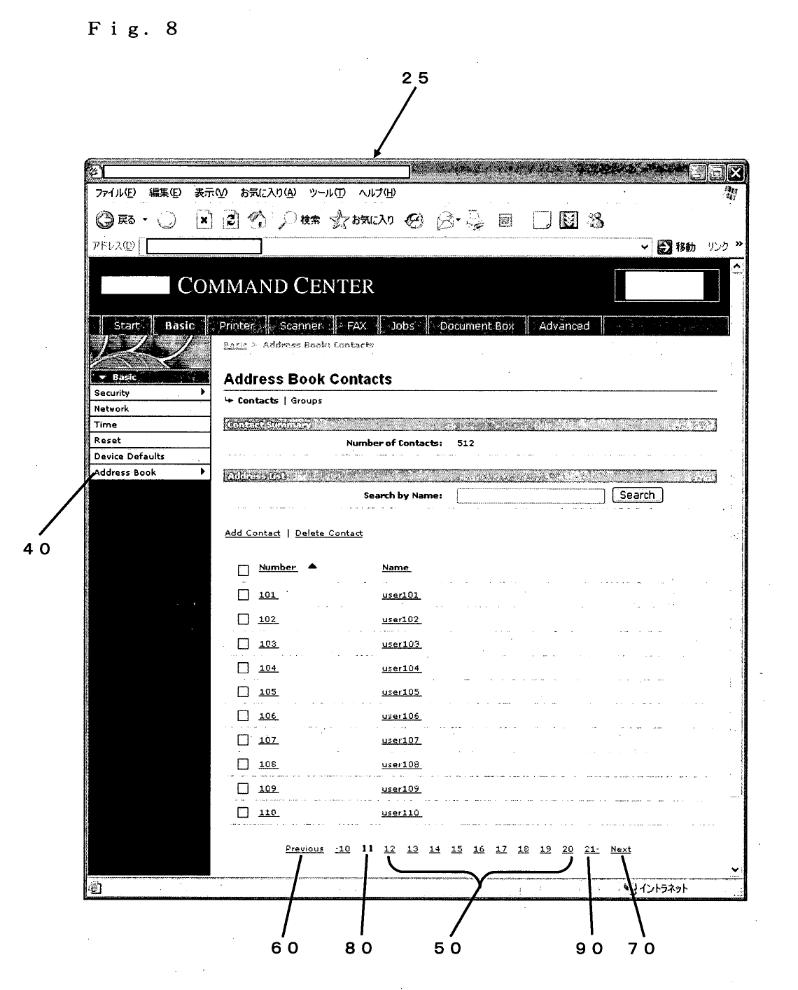

For instance, clicking “11-” of the jump button 90 proceeds to the page 11. As shown in FIG. 8, ten items of user registration numbers and names (101-110) will be displayed. Additionally, “Previous” of the button 60, “-10” of a jump button 80, “11” of the current display page, the page link buttons 50 of “12,” “13,” “14,” “15,” “16,” “17,” “18,” “19,” and “20,” “21-” of the jump button 90, and “Next” of the button 70 will be also displayed. The current displayed page number “11” will not be underlined.

On the eleventh page in FIG. 8, the user can selectively click either “Previous” of the button 60, “-10” of the jump button 80, the page numbers, “12,” “13,” “14,” “15,” “16,” “17,” “18,” “19,” and “20,” of the page link button 50, “21-” of the jump button 90, or “Next” of the button 70. Clicking it moves to the display of the selected page.

For instance, clicking “Previous” of the button 60 or “-10” of the jump button 80 proceeds to the display of the page “10.” Clicking “Next” of the button 70 or the page number “12” of the page link button 50 proceeds to the display of the page “12.” As shown in FIG. 9, ten items of user registration numbers and names (111-120) will be displayed. Additionally, “Previous” of the button 60, “-10” of the jump button 80, “12” of the current display page number, the page link buttons 50 of “13,” “14,” “15,” “16,” “17,” “18,” “19,” and “20,” “21-” of the jump button 90, and “Next” of the button 70 will be also displayed. The current displayed page number “12” will not be underlined.

More specifically, the MPU 11 of an image forming device 10 displays up to ten items of user registration numbers and names per page on the screen of the operation/display panel 25.

Furthermore, the MPU 11 displays a given number of page number values of pages near a current page as the page link buttons 50.

The page link 50 will be selected and clicked through an input operation at the operation/display panel 25. Then, the MPU 11 configures the page number value of the selected page link button 50 as the new display page number value and displays associated data by page.

Additionally, the MPU11 displays on the screen of the operation/display panel 25 the button 60 (“Previous”) for designating, in relation to a current page, the previous page and the button 70 (“Next”) for designating the next page.

Selecting the button 60 or the button 70 through input operation at the operation/display panel 25 causes the MPU 11 to configure a page number value of the page forwarded or moved back by one from the current page as the new display page number value and display associated data by page.

More specifically, clicking “Next” of the button 70 forwards the current page by one page, and clicking “Previous” of the button 60 moves back by one page from the current page.

Furthermore, the MPU 11 displays the jump buttons 80 and 90 which indicates the range of ten pages which includes according ten page link buttons 50, such as “-10” and “21-.”

Clicking the jump buttons 80 or 90 through an input operation at the operation/display panel 25 causes the MPU 11 to configure the selected page range as the new set of ten display page number values and display associated data by page. Additionally, the previous and/or the next rage of ten pages will be displayed as the jump button(s) 80 and/or 90.

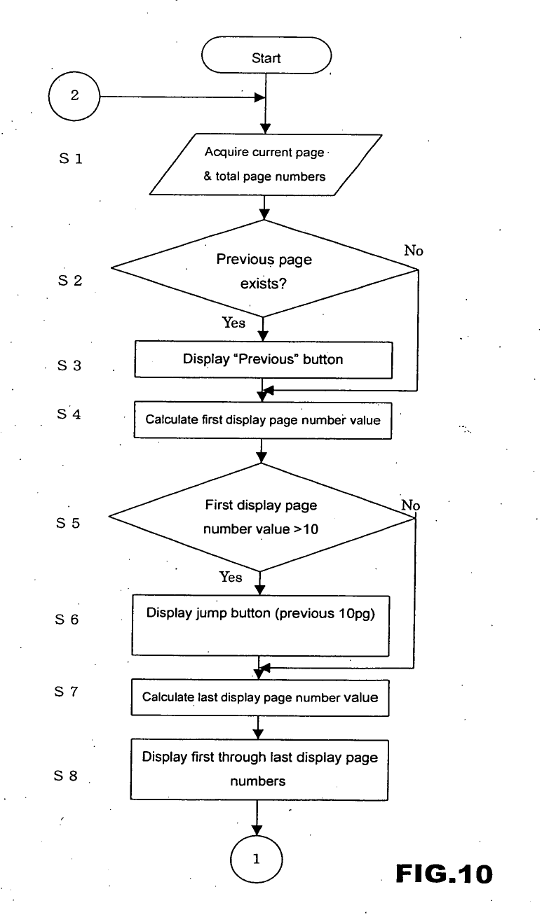

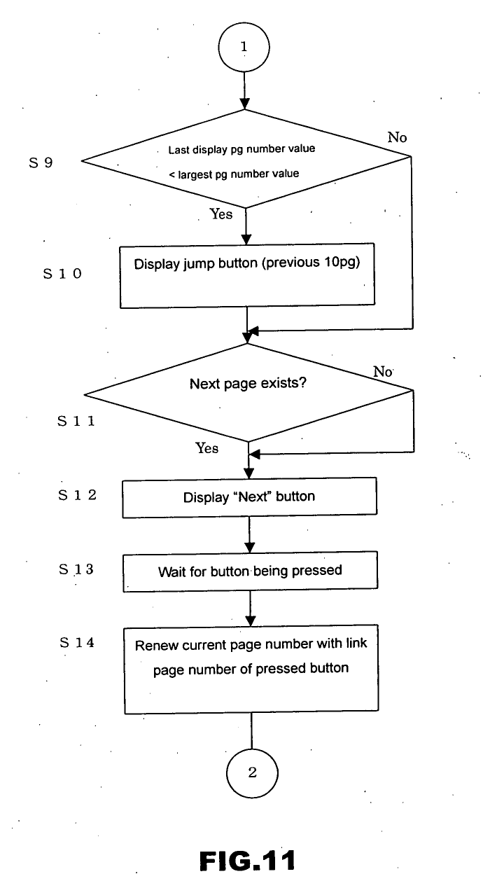

The MPU 11 of the image forming device 10 displays data for the user search by page and controls reception of an input. The reception control is performed in steps illustrated by flowcharts of FIGS. 10 and 11.

In step S1, clicking the address book button 40 on the screen of the operation/display panel 25 activates the processing function of the address book for searching registered users. Upon the activation, the MPU 11 receives a current display page number and a total page number from the HDD 14

In step S2, the MPU 11 determines whether there is a previous page.

If the result in step S2 is “NO,” which means a previous page does not exist and displaying “Previous” of the button 60 is unnecessary, operation proceeds to step S4. Alternatively, if the result is “YES,” in other words, if the previous page exists and the button 60 needs to be displayed, the MPU 11 displays the button 60 on the screen of the operation/display panel 25 in step S3.

In step S4, the MPU 11 calculates the first page number to display at the bottom of page, based on the current display page number, the total page number, and the page display item number (user registration numbers and names).

In step S5, the MPU 11 determines whether the value of the first page number acquired in step S4 is larger than the value “10,” more precisely, whether or not a page previous to the page number acquired in step S4 exists.

If the result of step S5 is “NO,” in other words, the value of the first page number acquired in step S4 is smaller than the value “10” and a previous page does not exit, operation proceeds to step S7. If the result is “YES,” which means a page previous to the first page number acquired in step S4 exists, the jump button 80 for enabling jumping ten pages back will be displayed in step S6. The page number to be jumped to will be “1,” “11,” “21,” “31,” and the like.

In step S7, the MPU 11 calculates the last page number, based on the current display page number, the total page number, and the page display item number.

In step S8, the MPU 11 displays at the bottom of the screen of the operation/display panel 25 a range of page numbers starting from the one acquired in step S4 through the one acquired in step S7.

In step S9, the MPU 11 determines the value of the last display page number is smaller than that of the largest page number.

If the result in step S9 is “NO,” more precisely, the last display page number value is larger than the largest page number value and the next page does not exist, the MPU 11 moves the operation to step S11. Alternatively, if the result in step S9 is “YES,” which means the last display page number value is smaller than the largest page number value, the next page exists, and displaying the jump button 90 for the following ten pages are necessary, the jump button 90 will be displayed in step S10. The link page numbers are either “11,” “21,” “31,” “41” or any other numbers which includes “first.”

In step S11, the MPU 11 determines whether the next page exists, based on the current display page number and the total page number.

If the next page does not exist and the result of step S11 is “NO,” the MPU 11 moves the operation to step S13. If the next page exists and the result of step S11 is “YES,” “Next” of the button 70 will be displayed in step S12.

In step S13, the MPU 11 waits for the buttons displayed in steps S 3, 6, 8, 10, and 12 to be pressed.

In step S14, the MPU 11 renews the display page number with a linked page number of the pressed button. Then, operation returns to the step S1.

The MPU 11 of the image forming device 10 displays up to ten items of user registration numbers and names per page on the screen of the operation/display panel 25.

Furthermore, the MPU 11 displays a given number of page number values of pages near a current page as the page link buttons 50.

The page link 50 will be selected and clicked through an input operation at the operation/display panel 25. Then, the MPU 11 configures the page number value of the selected page link button 50 as the new display page number value and displays associated data by page.

Accordingly, the user can access to a remote page only by clicking the page link button 50. Therefore, the invention spares him or her from inputting each page number, thereby improves usability.

Additionally, the MPU 11 displays on the screen of the operation/display panel 25 the button 60 (“Previous”) for designating, in relation to a current page, the previous page and the button 70 (“Next”) for designating the next page.

Selecting the button 60 or the button 70 through input operation at the operation/display panel 25 causes the MPU 11 to configure a page number value of the page forwarded or moved back by one from the current page as the new display page number value.

More specifically, clicking “Next” of the button 70 forwards the current page by one page, and clicking “Previous” of the button 60 moves back by one page from the current page. Accordingly associated data will displayed by page with a simple operation.

Furthermore, the MPU 11 displays the jump buttons 80 and 90 which indicates the range often pages which includes according ten page link buttons 50, such as “-10” and “21-.”

Clicking the jump buttons 80 or 90 through an input operation at the operation/display panel 25 causes the MPU 11 to configure the selected page range as the new set of ten display page number values and display associated data by page. Additionally, the previous and/or the next rage of ten pages will be displayed as the jump button(s) 80 and/or 90.

Therefore, the user can access to a remote page with a simple operation, and thereby the usability will be improved.

The present document incorporates by reference the contents of Japanese priority document, Japanese Patent Application No. 2006-180134, filed in Japan on Jun. 29, 2006.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth. There are changes that may be made without departing from the spirit and scope of the invention.

Any element in a claim that does not explicitly state “means for” performing a specific function, or “step for” performing a specific function, is not to be interpreted as a “means” or “step” clause as specified in 35 U.S.C. 112, Paragraph 6. In particular, the use of “step(s) of” or “method step(s) of” in the claims herein is not intended to invoke the provisions of 35 U.S.C. 112, Paragraph 6.

What is claimed is:

1. A data input-output device, comprising:
a data input unit;
a display unit which displays data to be selected through an input operation at the data input unit; and
a display control unit which controls displaying the data on a screen of the display unit by page.

2. The data input-output device of claim 1, wherein:
the display control unit displays on the screen of the display unit data to be selected from the displayed page and a given number of page number values of pages near a current page as page link buttons, and
upon selection of the page link button through the input operation at the data input unit, configures the page number value of the selected page link button as a new display page number value and controls displaying of the data by page.

3. The data input-output device of claim 2, wherein:
the display control unit further displays on the screen of the display unit a button for designating the previous or the next page from the current page, and
upon selection of the button through an input operation at the data input unit, configures a page number value of the page forwarded or moved back by one from the current page as the new display page number value and controls displaying the data by page.

4. The data input-output device of claim 2, wherein:
the display control unit further displays on the screen of the display unit a jump button for jumping a page range which includes the page link buttons, and
upon selection of the jump button through an input operation at the data input unit, configures a page number value of the page reached by jumping the page range as the new display page number value and controls displaying the data by page.

5. The data input-output device of claim 3, wherein:
the display control unit further displays on the screen of the display unit a jump button for jumping a page range which includes the page link buttons, and
upon selection of the jump button through an input operation at the data input unit, configures a page number value of the page reached by jumping the page range as the new display page number value and controls displaying the data by page.
